(19) United States
(12) Patent Application Publication
(10) Pub. No.: US 2009/0286477 A1
(43) Pub. Date: Nov. 19, 2009

(54) Methods, Portable Electronic Devices, Systems and Computer Program Products Providing Electronic Versions of Information from Electronic Conference Room Whiteboards

(75) Inventor: Andrew Jonathan Braun, Cary, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 12/120,971

(22) Filed: May 15, 2008

(51) Int. Cl. H04B 7/005

(52) U.S. Cl. 455/41.2

(57) ABSTRACT

Methods, portable electronic devices, systems and computer program products for wirelessly transmitting information from an electronic whiteboard. A wireless connection is established between a portable electronic device and the electronic whiteboard. A digital copy of content of the electronic whiteboard is received at the portable electronic device over the established wireless connection.

### FIELD OF THE INVENTION

The present invention relates to electronic whiteboards, and, more particularly, to methods, systems, and computer program products for sharing information thereon.

### BACKGROUND OF THE INVENTION

Conference rooms are typically equipped with whiteboards that allow meeting participants to illustrate their thoughts and ideas. Recently, modern conference rooms have been equipped with electronic whiteboards that look just like regular whiteboards, but provide users the capability to print out the contents of the whiteboard. Some electronic whiteboards may be configured to be connected to a computer, such that the contents of the whiteboard can be downloaded to the computer and printed, saved, changed, faxed and/or mailed. The capability of retrieving the contents of the whiteboard may allow for dynamic team collaboration where the whole team can participate in, for example, a brainstorming session or meeting without making sure everything on the board is captured by writing down, typing it into the computer or the like. Whenever meeting participants want to capture the contents of the whiteboard, for example, when the whiteboard is full or the meeting is over, a simple button press copies the contents of the board onto paper or downloads the contents of the whiteboard to a computer.

### SUMMARY OF THE INVENTION

Some embodiments of the present invention provide methods, portable electronic devices, systems and computer program products for wirelessly transmitting information from an electronic whiteboard. A wireless connection is established between a portable electronic device and the electronic whiteboard. A digital copy of content of the electronic whiteboard is received at the portable electronic device over the established wireless connection.

In further embodiments of the present invention, a request for the content of the electronic whiteboard to transmit the portable electronic device over the established wireless connection may be made.

In still further embodiments of the present invention, the established wireless connection may be an ultra-wide band (UWB) connection, a wireless universal serial bus (USB) connection, a Wi-Fi connection or a near field communication (NFC).

In some embodiments of the present invention, the digital copy of the content of the electronic whiteboard may be automatically received at the portable electronic device without requesting the digital copy.

In further embodiments of the present invention, the received digital content may be stored at the portable electronic device. The stored digital content may be manipulated to provide a modified version of the stored digital content.

In still further embodiments of the present invention, the digital content may be stored with location, time and/or date information.

In some embodiments of the present invention, the received digital content may be transmitted to at least one other device.

Further embodiments of the present invention provide methods, portable electronic devices, systems and computer program products for providing information on an electronic whiteboard. A wireless connection is established between the electronic whiteboard and a portable electronic device. Current content of the electronic whiteboard is converted to a digital representation of the current content. The converted digital content is transmitted to the portable electronic device over the established wireless connection.

In still further embodiments of the present invention, a request may be received for the current content of the electronic whiteboard, wherein transmitting comprises transmitting the converted digital content to the portable electronic device responsive to the request.

In some embodiments of the present invention, the current content of the electronic whiteboard may be periodically transmitted to the portable electronic device.

In further embodiments of the present invention, the established wireless connection may be a near field communications (NFC) connection.

### BRIEF DESCRIPTION OF THE DRAWINGS

FIG. 1 is a schematic block diagram illustrating a network including portable electronic devices and an electronic whiteboard in accordance with some embodiments of the present invention.

FIG. 2 is a schematic block diagram illustrating a portable electronic device and a cellular communication system in accordance with some embodiments of the present invention.

FIGS. 3 through 6 are flowcharts illustrating methods according to various embodiments of the present invention.

### DETAILED DESCRIPTION OF EMBODIMENTS OF THE INVENTION

The present invention will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

Example embodiments are described below with reference to block diagrams and/or flowchart illustrations of methods, devices, systems and/or computer program products. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the functions/acts specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, example embodiments may be implemented in hardware and/or in software (including firmware, resident software, micro-code, etc.). Furthermore, example embodiments may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of data processing systems discussed herein may be written in a high-level programming language, such as Java, AJAX (Asynchronous JavaScript), C, and/or C++, for development convenience. In addition, computer program code for carrying out operations of example embodiments may also be written in other programming languages, such as, but not limited to, interpreted languages. Some modules or routines may be written in assembly language or even micro-code to enhance performance and/or memory usage. However, embodiments are not limited to a particular programming language. It will be further appreciated that the functionality of any or all of the program modules may also be implemented using discrete hardware components, one or more application specific integrated circuits (ASICs), or a programmed digital signal processor or microcontroller.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

For purposes of illustration and explanation only, various embodiments of the present invention are described herein in the context of a portable electronic device, specifically a mobile terminal. It will be understood, however, that the present invention is not limited to such embodiments and may be embodied generally in any device that is capable of performing operations in accordance with some embodiments of the present invention.

Modern conference rooms are typically equipped with electronic whiteboards that look just like regular whiteboards, but provide users the capability to print out the contents of the whiteboard. Some electronic whiteboards may be configured to be connected to a computer such that the contents of the whiteboard can be downloaded to the computer and printed, saved, changed, faxed and/or emailed. The capability of printing the contents of the whiteboard may allow for dynamic team collaboration where the whole team can participate in, for example, a brainstorming session or meeting without being distracted by writing everything on the board down, typing it into the computer or the like. Whenever meeting participants want to capture the contents of the whiteboard, for example, when the whiteboard is full or the meeting is over, a simple button press may copy the contents of the board onto paper or download the contents of the whiteboard to a computer.

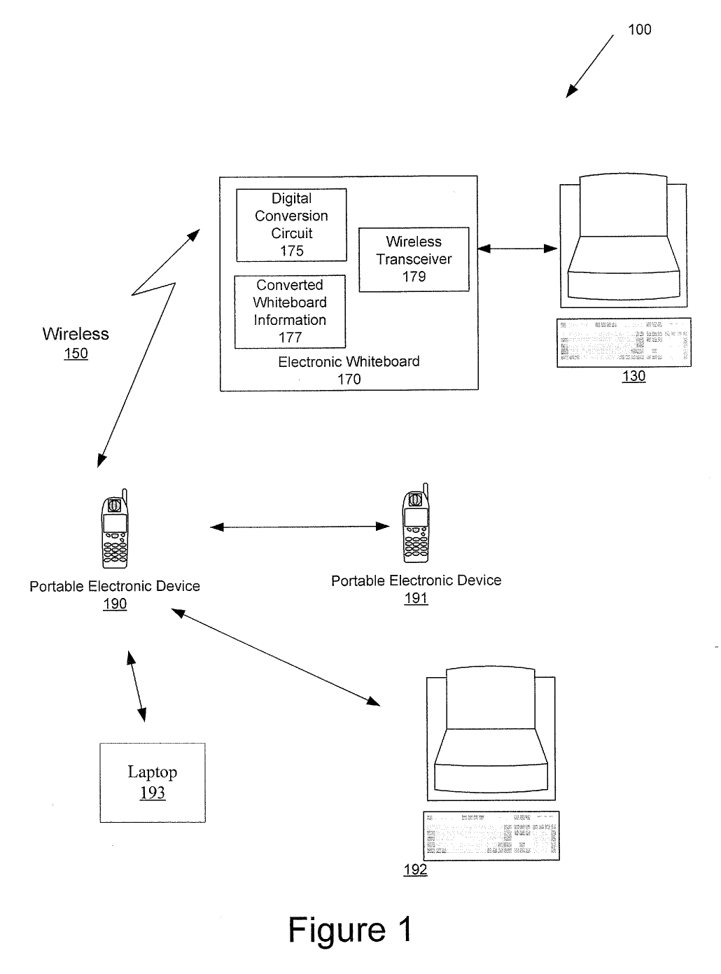

However, paper copies or electronic copies stored on a computer are hard to share, update and collaborate on outside of the meeting room. Thus, some embodiments of the present invention provide methods, systems and computer program products for wirelessly transmitting content of an electronic whiteboard to a portable electronic device. Wireless technologies in the portable electronic devices may be used capture and electronically distribute the contents of the electronic whiteboard. Having the electronic version of the content of the whiteboard in the portable electronic device may provide advantages over paper copies as will be discussed with respect to FIGS. 1 through 6 below.

Referring first to FIG. 1, a system 100 in accordance with some embodiments of the present invention may include an electronic whiteboard 170 associated with a computer, one or more portable electronic devices 190, 191, a laptop computer 193 and a desk top computer 192. It will be understood that although the computer 130 is illustrated as being separate from the electronic whiteboard 170 in FIG. 1, embodiments of the present invention are not limited to this configuration. For example, the electronic whiteboard 170 and the computer 130 can be combined without departing from the scope of the present invention. Furthermore, although embodiments of the present invention illustrated in FIG. 1 include a single computer 130 and electronic whiteboard 170, two portable electronic devices 190, 191, a single laptop computer 193 and a single desktop computer 192, embodiments of the present invention are not limited to this configuration. Any number of these devices or additional devices may be included without departing from the scope of the present invention.

As illustrated in FIG. 1, the portable electronic device 190 in the system 100 is configured to establish a wireless connection 150 between the electronic whiteboard 170 and the portable electronic device 190. The wireless connection 150 can be any type of wireless connection without departing from the scope of the present invention. For example, the wireless connection may be an ultra-wide band (UWB) connection, a wireless universal serial bus (USB) connection, a Wi-Fi connection or a near field communication (NFC) connection.

NFC is a standards-based (Ecma-340, ISO/IEC 18092), short-range wireless connectivity technology that may enable simple and safe two-way interactions among electronic devices, operating in the 13.56 MHz frequency range, over a typical distance of a few centimeters. NFC may use magnetic field induction to enable communication between devices when they're touched together, or brought within a few centimeters of each other. For example, NFC may be used to allow two or more portable electronic devices to exchange data. Instead of performing manual configurations, the connection between devices may be established automatically (<0.1 s). The underlying layers of NFC technology follow universally implemented ISO, ECMA and ETSI standards. Because the transmission range is so short, NFC-enabled transactions are inherently secure. Furthermore, proximity of the devices may give users the reassurance of being in control of the process. NFC can be used with a variety of devices, for example, mobile phones that enable payment or transfer information to digital cameras that send their photos to a TV set with just a touch. Details of securing electronic whiteboards using NFC sessions are discussed in detail in commonly assigned U.S. patent application Ser. No. ______ (Attorney Docket No. 9314-198), entitled METHODS, PORTABLE ELECTRONIC DEVICES, SYSTEMS AND COMPUTER PROGRAM PRODUCTS FOR SECURING ELECTRONIC CONFERENCE ROOM WHITEBOARDS, filed concurrently herewith, the disclosure of which is hereby incorporated herein by reference as if set forth in its entirety. Some embodiments of the present invention may be used in combination of embodiments discussed therein without departing from the scope of the present invention.

As used herein, the term “portable electronic device” includes: a cellular radiotelephone with or without a multi-line display; a Personal Communications System (PCS) terminal that combines a cellular radiotelephone with data processing, facsimile and data communications capabilities; a Personal Data Assistant (PDA) that includes a radiotelephone, pager, Internet/intranet access, Web browser, organizer, calendar and/or a global positioning system (GPS) receiver; a gaming device, an audio video player, and a conventional laptop and/or palmtop portable computer that includes a radiotelephone transceiver. Any portable electronic device capable of operating in accordance with some embodiments of the present invention may be used without departing from the scope of the present invention.

As further illustrated in FIG. 1, the electronic whiteboard 170 may include a digital conversion circuit 175 and a wireless transceiver 179. The wireless transceiver 179 of the electronic whiteboard 170 may be used to establish a wireless connection 150 between the portable electronic device 190 and the electronic whiteboard 170. The digital conversion circuit 175 may be configured to generate a digital representation of the current content of the whiteboard 170. This digital content of the electronic whiteboard 170 may be transmitted to the portable electronic device 190 over the established wireless connection 150. The digital conversion circuit 175 may generate the digital content responsive to a request for content from the portable electronic device 190, automatically after expiration of a timer or after the content is changed or the like without departing from the scope of the present invention. In some embodiments, the electronic whiteboard 170 may be configured to store the digital content at the electronic whiteboard 170 in the converted whiteboard information file 177. It will be understood that this converted information may also be stored on an external server, at the portable electronic device 190 or the like without departing from the scope of the present invention. The portable electronic device 190 may receive the digital copy of content of the electronic whiteboard 170 over the established wireless connection 170. As discussed above, the portable electronic device 190 may receive the digital content responsive to a request for the content or automatically without departing from the scope of the present invention. The received digital content may be stored at the portable electronic device 190 and may be manipulated to provide a modified version of the stored digital content. In some embodiments of the present invention, the digital content may be stored with location, time and/or date information. The user of the portable electronic device 190 may transmit the received or manipulated content to one or more other devices 192, 193. For example, these devices may be used by other member of the conference or team.

Operations according to some embodiments of the present invention will be discussed with respect to the system 100 of FIG. 1. As discussed above, the portable electronic device 190 and the electronic whiteboard 170 are both equipped with a wireless transceiver, which includes a wireless data interface. The wireless connection may also be an ultra-wide band (UWB), wireless universal serial bus (USB), WiFi and the like type of connection without departing from the scope of the present invention. According to some embodiments of the present invention, instead of printing the contents of the whiteboard 170 or storing the content of the whiteboard 170, the digital conversion circuit 175 of the electronic whiteboard 170 converts the images on the electronic whiteboard 170 into a digital format. This digital image may be transmitted via the established wireless connection 150, for example, the UWB, wireless USB or WiFi on a peer to peer basis. Since the portable electronic device 190 includes an abundance of storage, the user of the portable electronic device 190 may no longer have a need to print copies of the brainstorming session because the file may be stored on the portable electronic device. In some embodiments of the present invention, the setup of the wireless connection 150 between the electronic whiteboard 170 and the portable electronic device 190 can be established via an NFC connection, discussed above. The security credential setup can also be used to keep track of cost center information when printing is used. In other words, the amount of printing may be tracked so that it could possibly be billed to a client or the like.

Whiteboards 170 according to some embodiments of the present invention may have advantages over conventional printable whiteboard. For example, having the ability to transfer content wirelessly to a portable electronic device may reduce, or possibly eliminate, the need for a printing mechanism associated with the electronic whiteboard 170. This may lead to a reduction in the costs of paper, toner and the mechanics associated with the printing. The portable electronic device 190 receives a soft copy of the contents, which can be manipulated and transmitted to others. The soft copy can also be backed up on a network device at a later time. Multiple snapshots of the meeting can be quickly taken throughout the meeting. As discussed above, the content can be stored with location, time date and other metadata using the intelligence of the portable electronic device 190. Including this information with the stored content may improve search ability thereof.

Transferring the digital content to the portable electronic device 190 may easily lend itself to visitor conference rooms or share offices where one does not want network access. Furthermore, the hardware used for wireless connectivity is standard in the most portable electronic devices 190 and typically would not add substantial cost to the end to end system, where each additional connectivity choice adds cost to the white board and may need regulatory approvals. The appropriate metadata for each individual whiteboard session may be easily associated with the user of the portable electronic device 190 receiving the digital content from the electronic whiteboard 170 and not the conference room itself.

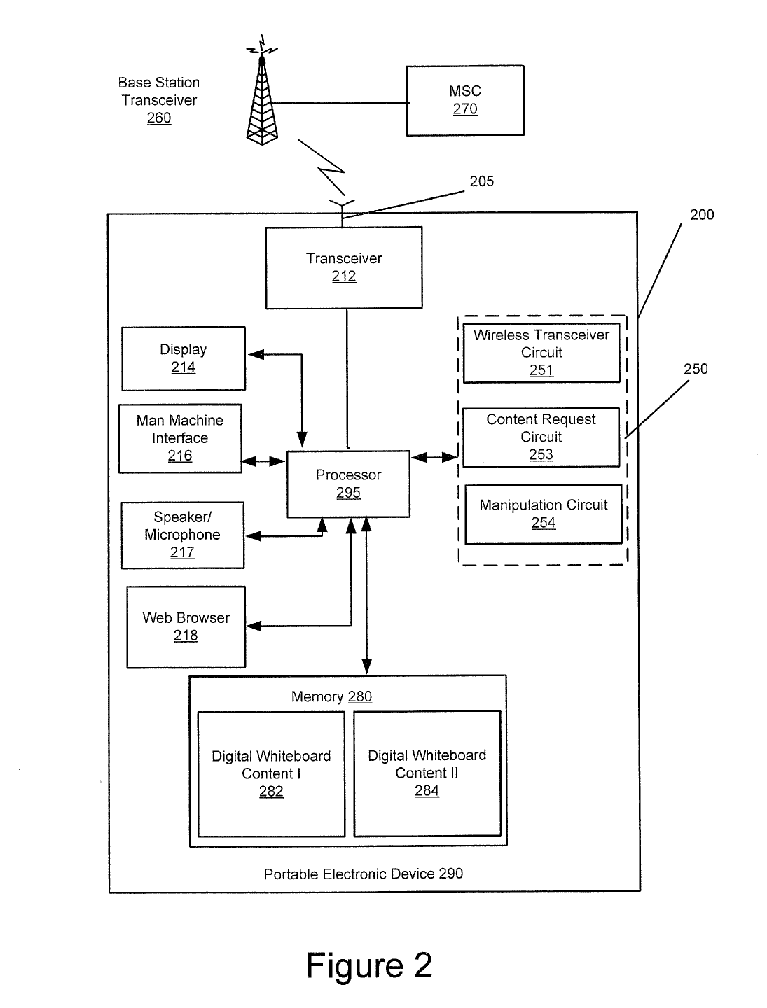

Referring now to FIG. 2, details with respect to portable electronic devices 290 in accordance with some embodiments of the present invention will be discussed. As illustrated in FIG. 2, the portable electronic device 290 includes a portable housing 200 and may include a display 214, a man machine interface (MMI) 216, a speaker/microphone 217, a web browser 218, a transceiver 212 and a memory 280, any of which may communicate with a processor 295. Furthermore, portable electronic devices 290 according to embodiments of the present invention may further include a sharing circuit 250 according to some embodiments of the present invention, which also communicates with the processor 295. The processor 295 can be any commercially available or custom microprocessor.

As further illustrated in FIG. 2, the portable electronic device 290 communicates with a base station transceiver 260 connected to a mobile switching center (“MSC”) 270 in accordance with some embodiments of the present invention. The transceiver 212 typically includes a transmitter circuit and a receiver circuit, which respectively transmit outgoing radio frequency signals to the base station transceiver 260 and receive incoming radio frequency signals, such as voice and data signals, from the base station transceiver 260 via an antenna 205. The antenna 205 may be an embedded antenna, a retractable antenna or any antenna known to those having skill in the art without departing from the scope of the present invention. The radio frequency signals transmitted between the portable electronic device 290 and the base station transceiver 260 may include both traffic and control signals (e.g., paging signals/messages for incoming calls), which are used to establish and maintain communication with another party or destination. The processor 295 may support various functions of the portable electronic device, including a sharing circuit 250 configured to establish a wireless connection with an electronic whiteboard as discussed above according to some embodiments of the present invention as will be discussed further herein.

It will be understood that in some embodiments of the present invention, the transceiver 212 may be a short range transceiver. The short range transceiver may be, for example, a Bluetooth transceiver, which may allow for high transfer rates of data over relatively short distances. It will be further understood that portable electronic devices 290 according to some embodiments of the present invention may include a wireless transceiver and a short range transceiver/transmitter without departing from the scope of the present invention.

In some embodiments of the present invention, the base station transceiver 260 includes the radio transceiver(s) that defines an individual cell in a cellular network and communicates with the portable electronic device 290 and other portable electronic devices in the cell using a radio-link protocol. Although only a single base station transceiver 260 is shown, it will be understood that many base station transceivers may be connected through, for example, a mobile switching center 270 and other devices to define a wireless communications network.

Although the present invention may be embodied in communication devices or systems, such as the portable electronic device 290, the present invention is not limited to such devices and/or systems. Instead, the present invention may be embodied in any apparatus that may be configured to operate in accordance with some embodiments of the present invention.

As illustrated in FIG. 2, the memory 280 includes digital whiteboard content I 282 and digital whiteboard content II 284. Although only two files are shown in the memory 280 of FIG. 2, any number of files may be stored without departing from the scope of the present invention. As further illustrated in FIG. 2, the sharing circuit 250 includes a wireless transceiver circuit 251, a content request circuit 253 and a manipulation circuit 254. Although three individual circuits are illustrated in FIG. 2, it will be understood that these circuits/modules can be split into four or more circuits/modules or combined into two or less circuits/modules without departing from the scope of the present invention.

Some embodiments of the present invention will now be discussed with respect to FIGS. 1 and 2. In particular, the wireless transceiver circuit 251 in combination with the transceiver 212 is configured to establish a wireless connection between the portable electronic device 290 and the wireless transceiver 179 of the electronic whiteboard 170. The digital conversion circuit 175 at the electronic whiteboard 170 is configured to convert current content of the electronic whiteboard 170 to a digital representation of the current content. The receiver 212 is configured to receive the digital content of the electronic whiteboard 170 at the portable electronic device 290 over the established wireless connection 150.

In some embodiments of the present invention, the content request circuit 253 is configured to request that the content of the electronic whiteboard 170 be transmitted to the portable electronic device 290 over the established wireless connection 150. In these embodiments, the digital conversion circuit 175 is configured to convert the content responsive to the request. It will be understood that in some embodiments of the present invention, the receiver 212 may be configured to receive the digital content of the electronic whiteboard 170 without requesting the digital copy. For example, the digital conversion circuit 175 may be configured to automatically general digital representations of the content of the electronic whiteboard 170 without being asked. In some embodiments, the digital conversion circuit 175 may generate the digital representation of the content periodically or when something on the electronic whiteboard 170 is changed.

As further illustrated in FIG. 2, the portable electronic device 290 may include a memory (a storage module) 280 configured to store the digital content at the portable electronic device 290. In some embodiments, the digital content may be stored with location, time and/or date information as discussed above. The manipulation circuit 254 may be configured to manipulate the stored digital content to provide a modified version of the stored digital content. The originally stored content or the modified content may be transmitted to another device, such as portable electronic device 191, desktop computer 192 and/or laptop computer 193.

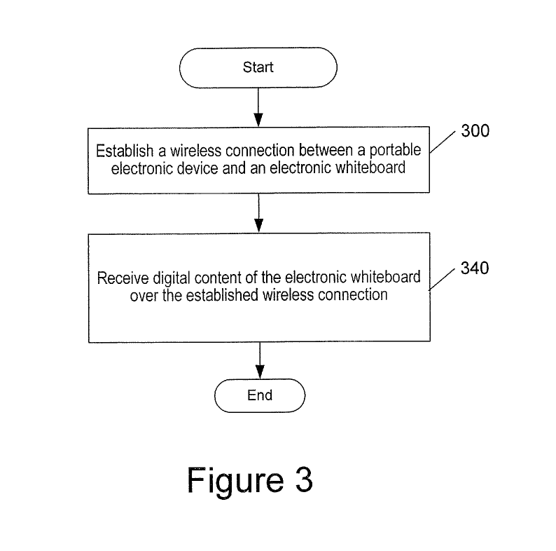

Referring now to FIGS. 3 through 6, operations according to various embodiments of the present invention will be discussed. Blocks denoted by dotted lines represent optional operations. Referring first to FIG. 3, operations for wirelessly transmitting information from an electronic whiteboard begin at block 300 by establishing a wireless connection between a portable electronic device and the electronic whiteboard. As discussed above, the established wireless connection may be a UWB connection, a wireless USB connection, a Wi-Fi connection or a NFC connection without departing from the scope of the present invention. A digital copy of content of the electronic whiteboard is received at the portable electronic device over the established wireless connection (block 340).

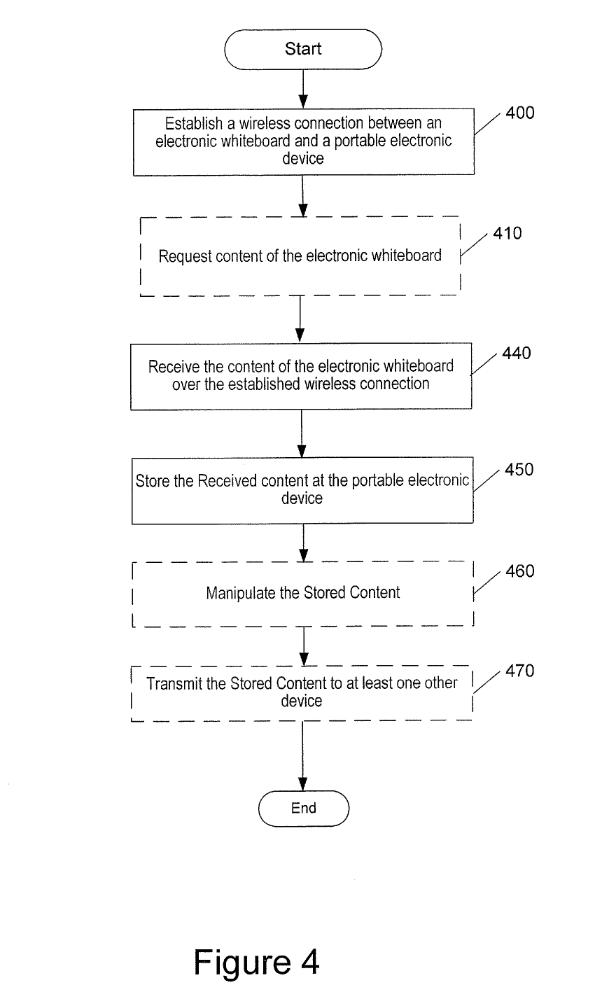

Referring now to FIG. 4, operations for wirelessly transmitting information from an electronic whiteboard begin at block 400 by establishing a wireless connection between a portable electronic device and the electronic whiteboard. Optionally, the content of the electronic whiteboard may be requested from the electronic whiteboard by the portable electronic device over the established wireless connection (block 410). It will be understood that in some embodiments of the present invention, the content may be automatically provided from the electronic whiteboard to the portable electronic device without a request by the portable electronic device. A digital copy of content of the electronic whiteboard is received at the portable electronic device over the established wireless connection (block 440). The received digital content may be stored at the portable electronic device (block 450). In some embodiments, the digital content may be stored with location, time and/or date information. Optionally, in some embodiments, the stored digital content may be manipulated to provide a modified version of the stored digital content (block 460). Optionally, the original stored content or the manipulated content may be transmitted to at least one other device (block 470).

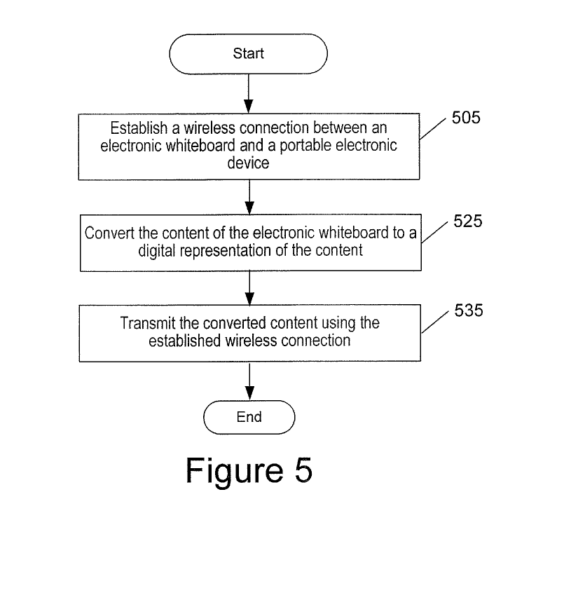

Referring now to FIG. 5, operations for providing information on an electronic whiteboard begin at block 505 by establishing a wireless connection between the electronic whiteboard and a portable electronic device. The current content of the electronic whiteboard is converted to a digital representation of the current content (block 525). The converted digital content is transmitted to the portable electronic device over the established wireless connection (block 535).

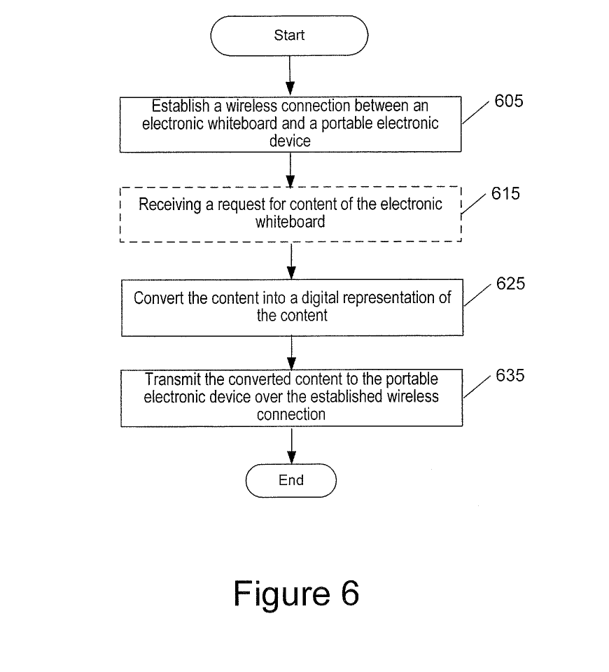

Referring now to FIG. 6, operations begin at block 605 by establishing a wireless connection between the electronic whiteboard and a portable electronic device. In some embodiments, a request may be received at the electronic whiteboard for the current content of the electronic whiteboard (block 615). In these embodiments, the converted digital content may be transmitted to the portable electronic device responsive to the request. It will be understood that a request for content is not required, the content may be automatically transmitted to the portable electronic device without departing from the scope of the present invention. The current content of the electronic whiteboard is converted to a digital representation of the current content (block 625). The converted digital content is transmitted to the portable electronic device over the established wireless connection (block 635).

In the drawings and specification, there have been disclosed exemplary embodiments of the invention. However, many variations and modifications can be made to these embodiments without substantially departing from the principles of the present invention. Accordingly, although specific terms are used, they are used in a generic and descriptive sense only and not for purposes of limitation, the scope of the invention being defined by the following claims.

That which is claimed:

1. A method for wirelessly transmitting information from an electronic whiteboard comprising:
establishing a wireless connection between a portable electronic device and the electronic whiteboard;
receiving a digital copy of content of the electronic whiteboard at the portable electronic device over the established wireless connection.

2. The method of claim 1, wherein receiving is preceded requesting that the content of the electronic whiteboard be transmitted to the portable electronic device over the established wireless connection.

3. The method of claim 1, wherein the established wireless connection comprises an ultra-wide band (UWB) connection, a wireless universal serial bus (USB) connection, a Wi-Fi connection or a near field communication (NFC).

4. The method of claim 1, wherein receiving comprises automatically receiving the digital copy of the content of the electronic whiteboard at the portable electronic device without requesting the digital copy.

5. The method of claim 1, further comprising:
storing the received digital content at the portable electronic device; and
manipulating the stored digital content to provide a modified version of the stored digital content.

6. The method of claim 5, wherein storing further comprising storing the digital content with location, time and/or date information.

7. The method of claim 1, wherein receiving is followed by transmitting the received digital content to at least one other device.

8. The method of claim 1 implemented by a portable electronic device.

9. The method of claim 1 implemented by a computer program product comprising a computer-readable storage medium having computer-readable program code embodied in said medium.

10. A method for providing information on an electronic whiteboard, comprising:
establishing a wireless connection between the electronic whiteboard and a portable electronic device;
converting current content of the electronic whiteboard to a digital representation of the current content; and
transmitting the converted digital content to the portable electronic device over the established wireless connection.

11. The method of claim 10, wherein converting is preceded by receiving a request for the current content of the electronic whiteboard, wherein transmitting comprises transmitting the converted digital content to the portable electronic device responsive to the request.

12. The method of claim 10, wherein transmitting comprises periodically transmitting the current content of the electronic whiteboard to the portable electronic device.

13. The method of claim 10, wherein the established wireless connection comprises a near field communications (NFC) connection.

14. The method of claim 10 implemented by a portable electronic device.

15. The method of claim 10 implemented by a computer program product comprising a computer-readable storage medium having computer-readable program code embodied in said medium.

16. A system for sharing content on an electronic whiteboard, the system comprising:
wireless transceiver circuit configured to establish wireless connection between a portable electronic device and the electronic whiteboard;
a digital conversion circuit at the electronic whiteboard configured to convert current content of the electronic whiteboard to a digital representation of the current content; and
a receiver configured to receive the digital content of the electronic whiteboard at the portable electronic device over the established wireless connection.

17. The system of claim 16, further comprising a content request circuit configured to request that the content of the electronic whiteboard be transmitted to the portable electronic device over the established wireless connection, wherein the digital conversion circuit is configured to convert the content responsive to the request.

18. The system of claim 16, wherein the receiver is further configured to receive the digital content of the electronic whiteboard without requesting the digital copy.

19. The system of claim if claim 16, further comprising:
a storage module configured to store the digital content at the portable electronic device; and
a manipulation circuit configured to manipulate the stored digital content to provide a modified version of the stored digital content.

20. The system of claim 19, wherein the storage module is further configured to store the digital content with location, time and/or date information.
